(19) United States
(12) Patent Application Publication
(10) Pub. No.: US 2024/0336097 A1
(43) Pub. Date: Oct. 10, 2024

(54) Ball Hitch with Lubricant Flow System

(71) Applicants: Justin Allen, Holton, KS (US); Cooper Allen, Howard, KS (US)

(72) Inventors: Justin Allen, Holton, KS (US); Cooper Allen, Howard, KS (US)

(21) Appl. No.: 18/613,949

(22) Filed: Mar. 22, 2024

Related U.S. Application Data
(60) Provisional application No. 63/494,307, filed on Apr. 5, 2023.

(51) Int. Cl. B60D 1/58; B60D 1/06

(52) U.S. Cl. CPC B60D 1/586; B60D 1/06

(57) ABSTRACT

A ball hitch includes a base flange, a coupler ball, and a stem portion connected between the coupler ball and the base flange. A lubricant inlet is mounted in the base flange within a recessed indentation. A lubricant outlet in the coupler ball is positioned at a lateral side opposite the lubricant inlet. A lubricant channel extending between the lubricant inlet and the lubricant outlet is canted at an angle through the ball hitch. The ball hitch provides an improvement for lubricant coating of the coupler ball, protection of the lubricant inlet, among other features disclosed herein.

### CROSS REFERENCES

This application claims the benefit of U.S. Provisional Application No. 63/494,307, filed Apr. 5, 2023.

### FIELD OF THE INVENTION

The present disclosure relates to ball hitches, in particular a ball hitch with a lubricant inlet and channel having arrangement for lubricating a contact surface within a coupler socket.

### BACKGROUND

Ball hitches couple a trailer, or portable implement, to a towing vehicle so the trailer may be towed together with the vehicle as one unit during transport. The ball hitch is made up of a coupler ball and a base connected by a stem portion. The coupler socket interlocks the trailer to a ball hitch on the vehicle. The ball hitch may have a threaded shank that allows for insertion through a ball mount. Once the ball hitch has been inserted and secured within the coupler socket of the trailer, then the trailer is ready for transport by the tow vehicle.

### SUMMARY

This disclosure relates to a ball hitch that includes: (a) a base; (b) a coupler ball; (c) a stem portion connected between the coupler ball and the base; (d) a lubricant inlet disposed in the base; (e) a lubricant outlet disposed in the coupler ball, which may be at a lateral side opposite the lubricant inlet; and (f) a lubricant channel extending between the lubricant inlet and the lubricant outlet.

In some aspects, the lubricant channel is disposed at an angle of between 15 degrees to 30 degrees to a central vertical axis of the coupler ball.

In some aspects, the lubricant channel extends horizontally through the base flange from the lubricant inlet towards the central vertical axis of the coupler ball.

In some aspects, the lubricant channel extends vertically in the central vertical axis through the coupler ball.

In some aspects, a lubricant fitting is disposed at the lubricant inlet within an indentation that is recessed into the base flange.

In some aspects, the lubricant fitting is a zerk that is countersunk and does not protrude from the base flange.

In some aspects, the diameter of the lubricant channel is from a sixteenth of an inch to a quarter of an inch.

In some aspects, the diameter of the lubricant channel is an eighth of an inch.

In some aspects, the diameter of the lubricant channel decreases from a quarter of an inch at the lubricant inlet down to less than or equal to a sixteenth of an inch at the lubricant outlet.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1 depicts a ball hitch with a lubricant fitting mounted in a threaded shank.

FIG. 2 depicts a cross section of the ball hitch depicted in FIG. 1.

FIG. 3 depicts a cross section of the ball hitch depicted in FIG. 1 with an indentation housing the lubricant fitting.

FIG. 4 depicts a cross section of the ball hitch depicted in FIG. 1 with a lubricant fitting flush with a distal end of the threaded shank.

FIG. 5 depicts another example of a ball hitch with at least one lubricant fitting mounted in a base flange.

FIG. 6 depicts another example of a ball hitch with a lubricant fitting mounted in a quick-release base.

FIG. 7 depicts a cross section of the ball hitch depicted in FIG. 6 with a base indentation housing the lubricant fitting.

FIG. 8 depicts a cross section of the ball hitch depicted in FIG. 6 with a lubricant insert flush with a sidewall of the base.

FIG. 9 depicts a cross section of the ball hitch depicted in FIG. 5 with a threaded lubricant inlet.

FIG. 10 depicts a cross section of the ball hitch depicted in FIG. 5 with a horizontal lubricant inlet connected to a vertical lubricant channel.

FIG. 11 depicts a cross section of the ball hitch depicted in FIG. 5 with a lubricant insert flush with a sidewall of the base flange.

### DETAILED DESCRIPTION

An improved ball hitch 100, 200 with a self-lubricating contact surface 135 may provide an advantage of reducing nuisance noise, heat, friction, and wear produced between the ball hitch 100, 200 and the coupler socket of a towed vehicle when moved during transport. The ball hitch 100, 200 includes a coupler ball 130 that may be spherical and a base flange 110 that may be cylindrical. A stem portion 120 that may be medially concaved connects the coupler ball 130 to the base flange 110. A lubricant channel 150 may extend between a lubricant outlet 160 in the coupler ball 130 on a first lateral side that is opposite a lubricant inlet 140 in the base flange 110 on a second lateral side. Arrangement of the lubricant inlet 140 aids access by an operator to insert lubricant into the ball hitch. The lubricant channel dispenses lubricant on the contact surface 135 of the ball hitch without detrimentally affecting the mechanical strength of the ball hitch.

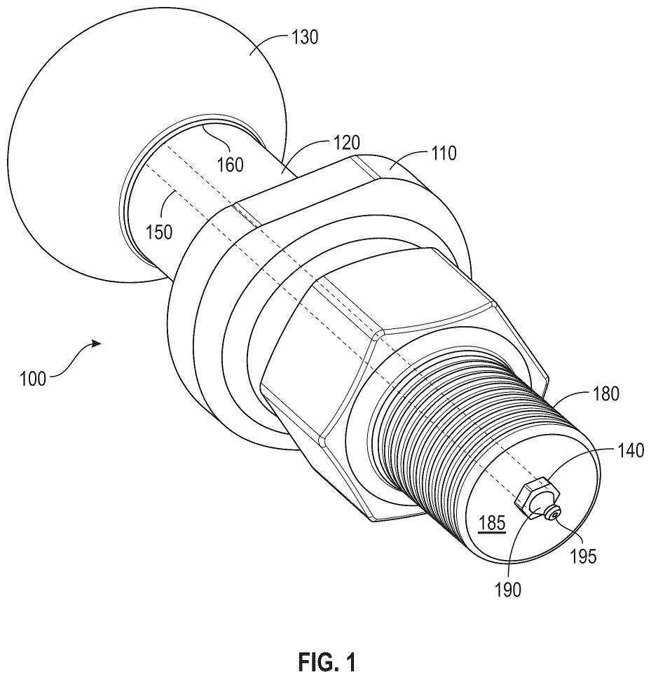

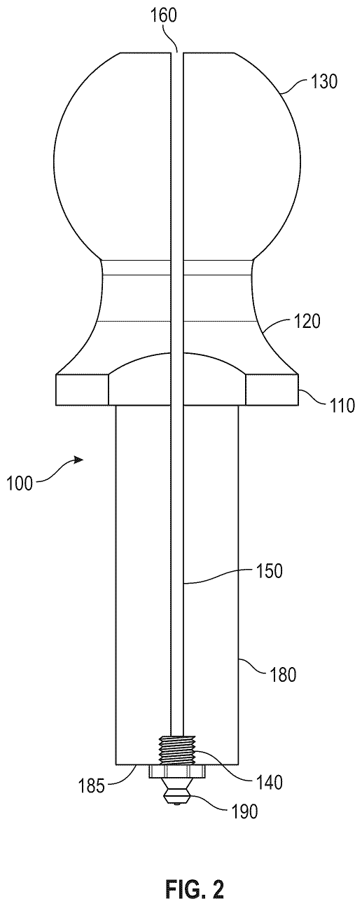

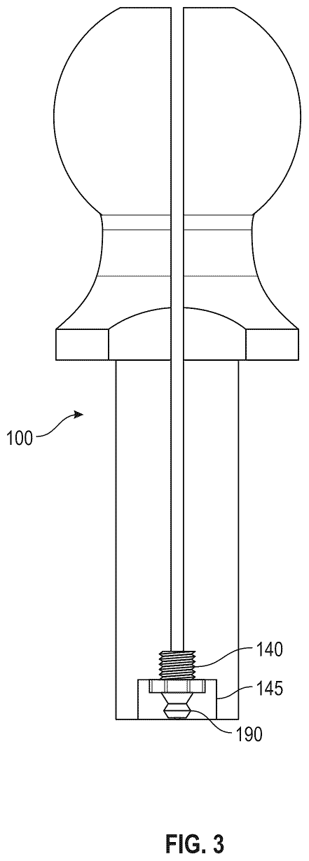

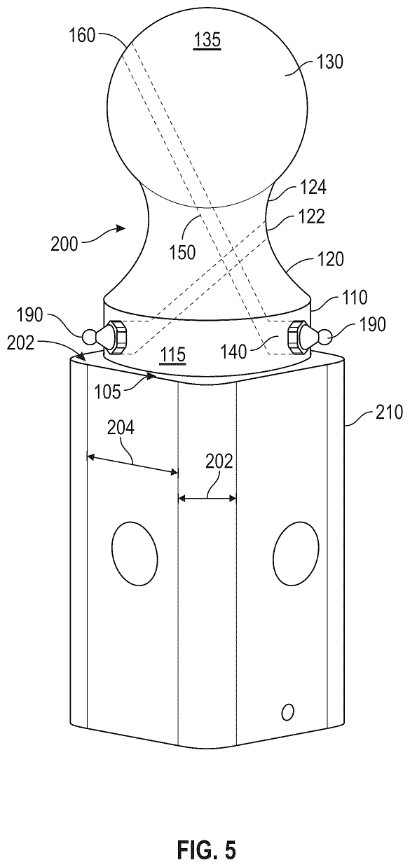

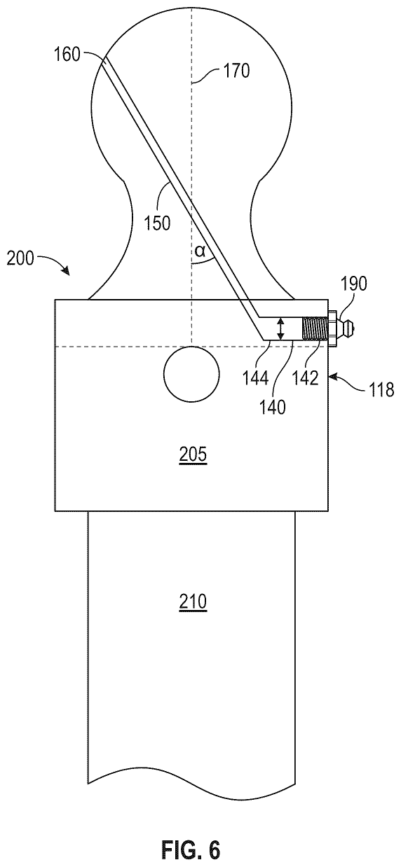

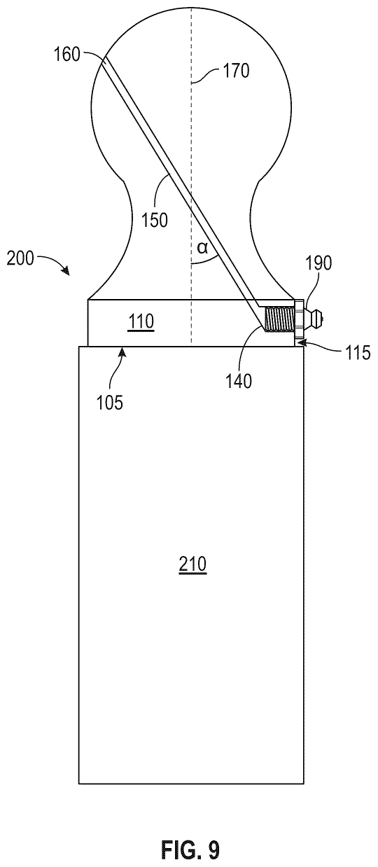

Details of the ball hitch are susceptible to many variations in different forms. Examples of a bumper hitch, generally shown in FIG. 1, are depicted in detail in FIGS. 2, 3, and 4. Specific dimensions of the lubricant inlet and lubricant channel are described in the figures and given in further detail below. Examples of an in-bed release ball hitch, generally shown in FIG. 5, are depicted in detail in FIGS. 6, 7, and 8. Examples of a turnover ball hitch are depicted in detail in FIGS. 9, 10, and 11. Specific dimensions of the lubricant channel 150 are described in the figures and given in further detail below. In the examples of ball hitch 200, the lubricant channel 150, that is angled, connects a lubricant outlet 160 to a lubricant inlet 140 positioned in the base flange 110. Specific embodiments, and particularly specific dimensions of those embodiments, are made with the understanding that the current disclosure is to be considered as an exemplification of the principles of the disclosure and is not to be limited to specific embodiments described.

Ball hitch 100 illustrated in FIG. 1 has a lubricant channel 150 that extends linearly through a threaded shank 180 within the central vertical axis 170 of the ball hitch 100. Alternatively, the lubricant channel 150 disposed through the stem portion 120 may be canted from the central vertical axis of the ball hitch 100, as shown in FIG. 5. A lubricant inlet 140 may be disposed in a distal end 185 of the threaded shank 180, as shown in FIG. 1. Alternatively, the lubricant inlet 140 may be disposed in a sidewall 115 of the base flange 110, as shown in FIG. 5.

Ball hitch 100 illustrated in FIG. 5 is an example of a ball hitch utilized to haul a gooseneck type trailer. In some cross sections, as shown in FIGS. 6, 7, and 8, a lubricant channel 150 is shown extending through the stem portion 120 at an oblique angle from the central vertical axis 170 of the ball hitch 100. Alternatively, the lubricant channel 150 may extend through the stem portion 120 and align with the central vertical axis 170 of the ball hitch 100, as shown in FIG. 9. The lubricant channel is fluidly connected to lubricant inlet 140.

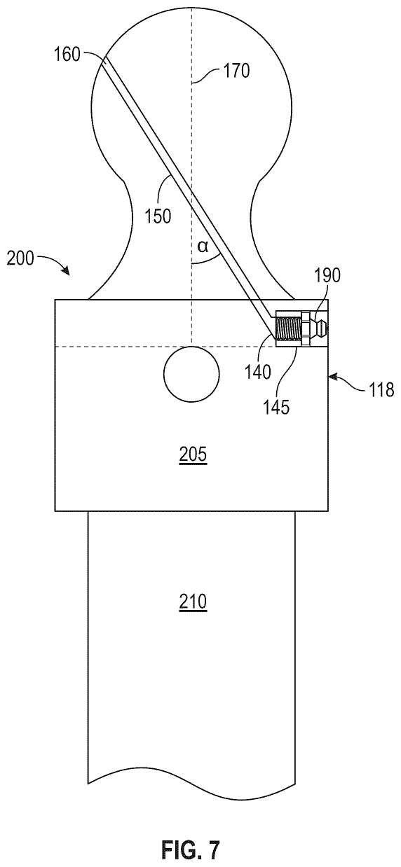

The lubricant inlet 140 may be disposed in a distal end 185 of the threaded shank 180. As shown in FIGS. 1, 2, 3, and 4, the lubricant inlet 140 is vertically aligned with the lubricant channel 150. Alternatively, lubricant inlet 140 may not align with central vertical axis 170 of the ball hitch or the lubricant channel 150 extending through the stem portion 120 of the ball hitch. As shown in FIGS. 9, 10, and 11, the lubricant inlet 140 is horizontally aligned and parallel with floor 105 of the base flange 110. The lubricant inlet 140 may be a smooth or threaded bore disposed in the base of the ball hitch. In the ball hitch examples shown in FIGS. 7, 9, and 11, the lubricant inlet 140 is a threaded bore. Alternatively, in the ball hitch examples shown in FIGS. 6, 8, and 10, the lubricant inlet 140 is a threaded bore along a first portion 142 and smooth-bored along a second portion 144.

The diameter of the lubricant inlet 140 may be between 0.0625 of an inch ( 1/16″) to 1.0 inch. The diameter of the lubricant inlet 140 may be further between 0.125 of an inch (⅛″) to 0.5 of an inch (½″), between 0.10938 of an inch ( 7/64″) to 0.25 of an inch (¼″), between 0.0625 of an inch ( 1/16″) to 0.25 of an inch (¼″), between 0.125 of an inch (⅛″) to 0.25 of an inch (¼″), between 0.25 of an inch (¼″) to 0.5 of an inch (½″). The diameter of the lubricant inlet 140 may be 0.125 of an inch (⅛″) or 0.25 of an inch (¼″).

As shown in FIGS. 1, 2, 3, and 4, the lubricant inlet 140 may be disposed in a threaded shank 180. Alternatively, as shown in FIGS. 5, 6, 7, 8, 9, 10, and 11, the lubricant inlet 140 may be disposed in the base flange 110. The lubricant inlet 140 may be disposed within an indentation 145 that is recessed. The indentation 145 may be rececessed in a base of the ball hitch 100, such as the threaded shank 180 or the base flange 110.

A lubricant fitting 190 may be disposed within indentation 145 so as not to protrude beyond an exterior surface of the ball hitch 100. The distal edge of the lubricant fitting 190 may be flush with an exterior surface of ball hitch 100, such as the distal end 185 of the threaded shank 180 or the sidewall 115 of the base flange 110. An advantage to having the lubricant fitting 190 that is recessed may be the reduction or prevention of debris and other foreign matter from entering and collecting within the lubricant inlet 140. Additionally, the lubricant fitting 190 may be protected from breakage when countersunk within indentation 145 so as not to protrude. The lubricant fitting 190 disposed within an indentation 145 in the base flange 110 may provide easier access for an operator to inject lubricant into lubricant fitting 190, rather than if the lubricant fitting 190 is disposed on an underside of the ball hitch 100 beneath the ball mount platform.

A lubricant may be fed through the lubricant fitting 190 into the lubricant inlet 140, with or without pressure, when injected by a liquid dispenser. Lubricants, which are substances that reduce friction, heat, and noise produced between moving surfaces in mutual contact, may include: grease, silicone, oil, or dry powder, such as graphite or talc.

Usually, the lubricant is injected into the lubricant inlet 140 with a lubricant dispenser. The lubricant dispenser, which contains an amount of lubricant, may include a discharge end and a reservoir container. Examples include nipple bottles, spray cans, grease guns, or other all-purpose lubricant dispensers. The liquid dispenser can be utilized to inject the lubricant into the lubricant inlet 140 directly through the lubricant fitting 190.

In scenarios where lubricating grease is used as the lubricant, the lubricant fitting 190 may be a grease fitting, grease nipple, grease zerk, or other metal fittings used in mechanical systems to feed lubricants. For example, the lubricant fitting 190 shown in FIGS. 1, 2, 3, 5, 6, 7, 9, and 10 is a grease zerk threaded into the lubricant inlet 140. The zerk shown is a straight grease fitting but may be have other angles such as 45 degree or 90 degree. The zerk shown serves as an injection point for the lubricating grease, so grease may be inserted at a specific area of the ball hitch. An inlet opening 195 of the zerk may have a diameter that is substantially coextensive with the diameter of the lubricant channel 150.

The lubricant inlet 140 may be threaded or smooth and be configured to receive the lubricant fitting 190. The lubricant fitting 190 may be mechanically joined, welded, or have an interlock connection with the lubricant inlet 140.

The lubricant fitting 190 may be protected within an indentation 145. Indentation 145 that is recessed in a base of the ball hitch may provide the advantage that the lubricant fitting 190 is less likely to be broken off.

As shown in FIG. 5, lubricant fitting 190 may be mounted on a sidewall 115 of the base flange 110. If the lubricant fitting 190 is not recessed within an indentation 145, then the lubricant fitting 190 may be disposed above a corner projection 202 of a base post 210 mounted to the ball hitch 200. A lubricant fitting 190 disposed above the corner projection 202, versus a side face 204 of the ball hitch 200, is protected because the lubricant fitting 190 does not jut out beyond a plane of the side face 204 of the base post 210. In the gooseneck type, the ball hitch 200 may be rotated, flipped, or folded down into the bed of the truck. If the lubricant fitting 190 is flush with the sidewall of the base flange 110, recessed, or positioned at a corner of the base post 210, then it may be less likely that the lubricant fitting 190 is damaged.

A zerk utilized as the lubricant fitting 190 may be selected from varied sizes, lengths, and channel diameters. The channel diameter of the zerk may be between 0.01315 of an inch ( 1/76″) to 0.5 of an inch (½″). The channel diameter of the zerk may be further between 0.03125 of an inch ( 1/32″) to 0.5 of an inch (½″), between 0.10938 of an inch ( 7/64″) to 0.25 of an inch (¼″), between 0.0625 of an inch ( 1/16″) to 0.25 of an inch (¼″), between 0.125 of an inch (⅛″) to 0.250 of an inch (¼″), between 0.25 of an inch (¼″) to 0.5 of an inch (½″). The channel diameter of the zerk may be 0.625 of an inch ( 1/16″) to 0.125 of an inch (⅛″). The outside diameter of the zerk threads may be between 0.0625 of an inch ( 1/16″) to 0.5 of an inch (½″). The outside diameter of the zerk threads may be further between 0.125 of an inch (⅛″) to 0.5 of an inch (½″), between 0.10938 of an inch ( 7/64″) to 0.25 of an inch (¼″), between 0.0625 of an inch ( 1/16″) to 0.25 of an inch (¼″), between 0.125 of an inch (⅛″) to 0.25 of an inch (¼″), between 0.25 of an inch (¼″) to 0.5 of an inch (½″). The diameter of the lubricant inlet 140 may be 0.125 of an inch (⅛″) or 0.25 of an inch (¼″).

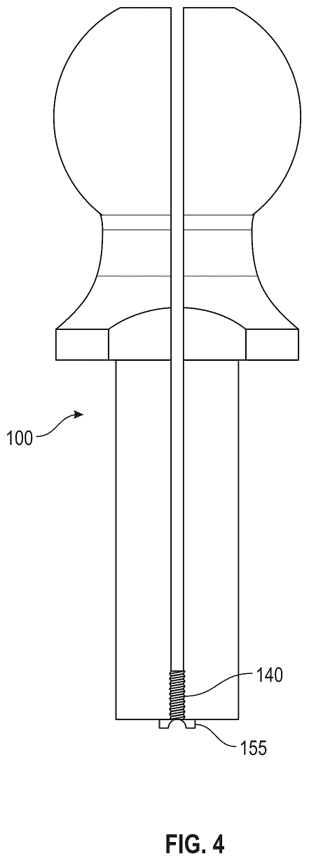

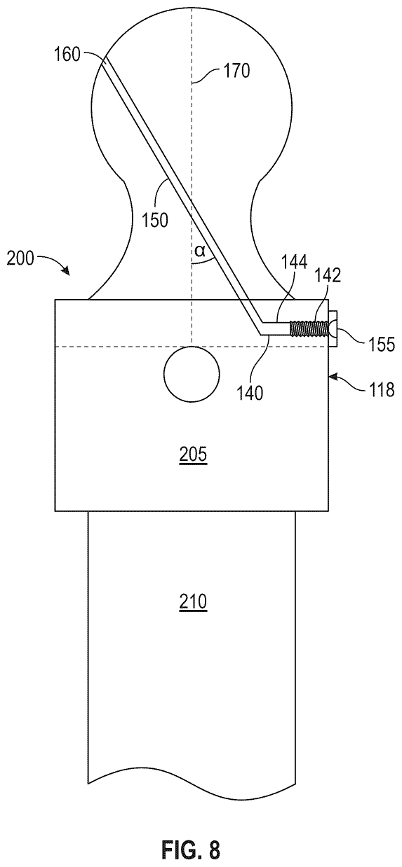

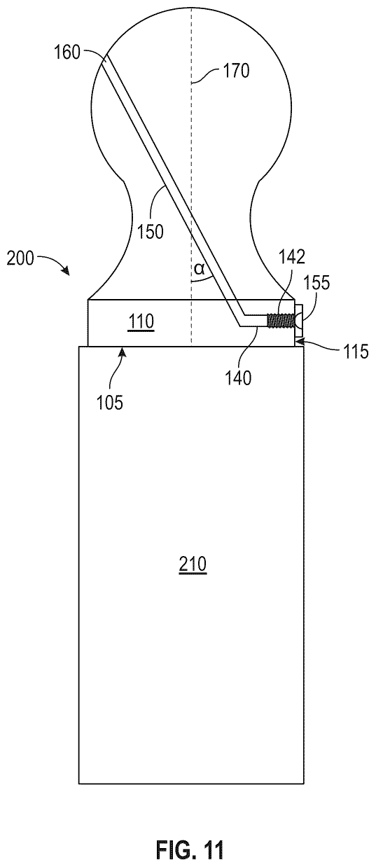

A tube or adapter may be used for connection with a variation of the ball hitch utilizing an inset port 155. As shown in FIG. 4, the inset port 155 is substantially flush with a distal end 185 of the threaded shank 180. FIG. 8 shows the inset port 155 mounted in the side face 204 of the base post 210 of an in-bed release type ball hitch. FIG. 11 shows the inset port 155 mounted in the sidewall 115 of the base flange 110. The lubricant passes through the ball hitch 100 by way of the lubricant channel 150 that is fluidly connected to the lubricant inlet 140.

The lubricant channel 150 can direct the transfer of a liquid or powder lubricant through an interior portion of the ball hitch 100 and dispense the lubricant on an exterior portion of the ball hitch 100. As shown in variations of FIG. 1, the lubricant channel 150 passes from a distal end 185 of the threaded shank 180 through the stem portion 120 to a lubricant outlet 160 disposed in the coupler ball 130. As shown in FIGS. 5-11, the lubricant channel 150 passes from the base flange 110 through the stem portion 120 to the lubricant outlet 160 disposed in the coupler ball 130. In FIGS. 1-4 and 10, the lubricant channel extends linearly along the central vertical axis 170 that extends longitudinally through the ball hitch 100. In FIGS. 5-9 and 11, the lubricant channel 150 extends longitudinally through the ball hitch at an oblique angle to the central vertical axis 170 that extends longitudinally through the ball hitch 200.

The lubricant channel 150 may be canted from the central vertical axis 170 at an angle (a) ranging between 5 degrees to 90 degrees. The angle (a) at which the lubricant channel 150 is canted from the central vertical axis 170 may be range further between, 15 degrees to 75 degrees, between 25 degrees to 65 degrees, between 15 degrees to 55 degrees, between 35 degrees to 75 degrees, between, between 15 degrees to 55 degrees, between 15 degrees to 45 degrees, between 15 to 30 degrees, and between 15 to 25 degrees.

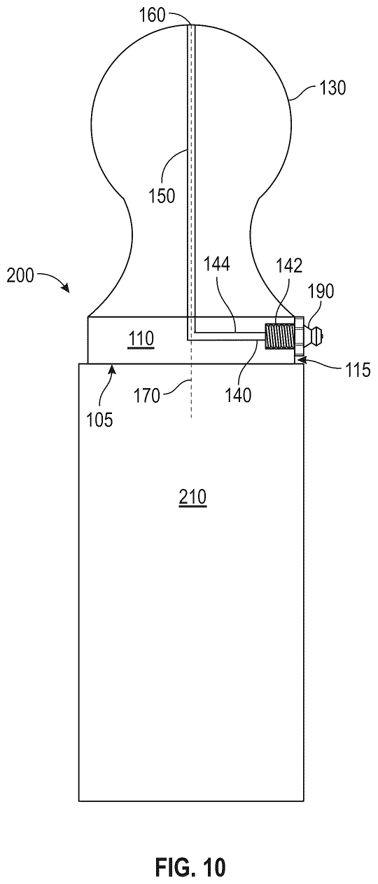

The lubricant inlet 140 and lubricant channel 150 may have varying diameters, angles, and configurations depending partially on the desired flow rate of the lubricant, structural stability of the ball hitch, and the viscosity of the intended lubricant. For example, in FIG. 6, the lubricant inlet 140 extends horizontally through base 205 from the sidewall 118 towards the central vertical axis 170 of the coupler ball 130. From the sidewall 118 of base 205, a first portion 142 of the lubricant inlet 140 is threaded over approximately 0.25 of an inch. A second portion 144 of lubricant inlet 140 is smooth-bored. The second portion 144 may have an approximate diameter of 0.25 of an inch (¼″). The lubricant channel 150, which is fluidly connected to the lubricant inlet 140, extends at an oblique angle vertically up through the coupler ball 130 towards a lubricant outlet 160. The lubricant outlet 160 is disposed in the coupler ball 130 at a lateral side opposite the lubricant inlet 140 in the base 205. The lubricant channel 150 may be smooth-bored to have an approximate diameter of 0.125 of an inch (⅛″). In another example, as shown in FIG. 10, the lubricant inlet 140 extends horizontally through the base flange 110 from the sidewall 115 towards the central vertical axis 170 of the coupler ball 130. From the sidewall 115 of the base flange 110, a first portion 142 of the lubricant inlet 140 is threaded over a distance of approximately 0.25 of an inch. The second portion 144 of lubricant inlet 140 is smooth bored over a distance of approximately 0.91 of an inch. The smooth-bored portion may have an approximate diameter of 0.125 of an inch (⅛″). The lubricant channel 150, which is fluidly connected to the lubricant inlet 140, extends vertically up through the central vertical axis 170 to dispense a lubricant on the apex of the coupler ball 130. The lubricant channel 150 may also have an approximate diameter of 0.125 of an inch (⅛″).

The diameter of the lubricant channel 150 may be between 0.01315 of an inch ( 1/76″) to 0.5 of inch (½″). The diameter of the lubricant channel 150 may be further between 0.03125 of an inch ( 1/32″) to 0.5 of an inch (½″), between 0.10938 of an inch ( 7/64″) to 0.25 of an inch (¼″), between 0.0625 of an inch ( 1/16″) to 0.25 of an inch (¼″), between 0.125 of an inch (⅛″) to 0.25 of an inch (¼″), between 0.25 of an inch (¼″) to 0.5 of an inch (½″). The diameter of the lubricant channel 150 may be 0.625 of an inch ( 1/16″) or 0.125 of an inch (⅛″). In some examples, the lubricant channel 150 may decrease from 0.25 of an inch (¼″) at the lubricant inlet 140 down to less than or equal to 0.0625 of an inch ( 1/16″) at the lubricant outlet 160. In other examples, the lubricant channel 150 may decrease from 0.25 of an inch (¼″) at the lubricant inlet 140 down to less than or equal to 0.125 of an inch (⅛″) at the lubricant outlet 160.

The lubricant outlet 160 may be disposed on either the contact surface 135 of the stem portion 120, the coupler ball 130, or both. The lubricant outlet 160 is in liquid communication with the lubricant inlet 140 through lubricant channel 150. As shown in FIG. 2, the lubricant outlet 160 is disposed in the coupler ball 130 at a lateral side opposite the lubricant inlet 140. Alternatively, a plurality of lubricant outlet ports may be disposed in the contact surface 135 of the stem portion 120 or coupler ball 130. The lubricant outlet 160 may be disposed in the lower half of the coupler ball 130. Alternatively, or in combination, the lubricant outlet 160 may be disposed in the upper half of the coupler ball 130. The lubricant outlet 160 may be disposed on an underside of the coupler ball 130 adjacent the stem portion 120. A coupler of a trailer may contact an arcuate portion of the stem portion 120 when hitched to the ball hitch. As shown in FIG. 1, an arcuate aperture may function as the lubricant outlet 160 to dispense lubricant down onto the contact surface of the stem portion 120. As shown in FIG. 5, grease channel 150 exits at lubricant outlet 160 disposed on the contact surface 135 of the coupler ball 130, while a second grease channel exits at a lubricant outlet disposed on the contact surface of a central edge 122 of the stem portion 120. The first grease channel and the second grease channel of FIG. 5 may be used as individual alternatives, or in combination. In an alternative configuration of the second grease channel, the lubricant outlet may exit along a peripheral edge 124 of the stem portion 120 that is distal to the coupler ball 130. In FIG. 5, the peripheral edge 124 is labeled at a position where the lubricant outlet of the second grease channel is proximal to the coupler ball.

The ball hitch may provide advantages over other ball-type hitches. The angled lubricant channel may increase the overall structural integrity of the ball hitch. Mechanical stresses such as weight, shear stress and forces act on the ball hitch during operating conditions. Placement of the lubricant channel at steeper angles displaces the lubricant inlet and outlet away from the central vertical axis 170. As a result, the percentage of metal-to-channel ratio may be higher with a lubricant channel 150 having a more oblique angle through a longitudinal length of the ball hitch.

Additionally, an increased factor of safety may result from a lubricant channel 150 which is angled to reduce or prevent substantial mechanical failure of the ball hitch. Linear or transverse cracks may form down the center or across a radius of the ball hitch if a lubricant channel is stationed within the central vertical axis 170. A ball hitch having a lubricant channel 150 canted away from the central vertical axis 170 may be less likely to shear off a substantial portion of the ball hitch during stressful operating conditions. Further, an angled lubricant channel may shorten the distance the lubricant travels between the lubricant inlet 140 and the lubricant outlet 160. Therefore, a greater amount of structural material may be retained during formation of the lubricant channel within the interior of the ball hitch.

FIGS. 5, 6, 7, 8, 9, and 11, are side elevation views of different variations of the ball hitch 200. In these examples, lubricant outlet 160 is positioned in the coupler ball 130 at a lateral side opposite the lubricant inlet 140. With lubricant outlet of the ball hitch 200 in the opposite lateral side, the lubricant inlet 140 in the base flange 110 may be more accessible by an operator when the ball hitch 200 is mounted. Based on positioning of the ball hitch 200, the lubricant inlet 140 may face towards a rearward end of the tow vehicle. Therefore, the lubricant outlet 160 in the coupler ball 130 may face towards a forward end of the tow vehicle. In a gooseneck trailer assembly, the attached trailer coupler may ride against the ball hitch 200 with a point of contact at or near the lubricant outlet 160. This ball hitch configuration and positioning may allow lubricant released from the lubricant outlet 160 to be smeared across the contact surface 135 of the coupler ball 130 and/or stem portion 120 as the trailer coupler pivots upon the ball hitch 200 while the tow vehicle turns.

The ball hitch may be manufactured in various shank lengths and diameters, ball diameters and weight capacities to meet the towing capacity selected. The ball hitch may be made of several different materials and finishes to realize operating advantages with the hitch assembly. For example, heat treated steel may be sufficiently durable for the intended application. Alternatively, a steel ball with chrome, nickel, zinc, or other finish coating might be selected. The ball hitch may also be lathed from a single unit of stainless or raw steel. The channel and lubricant inlet and outlets may be bored, drilled, or formed by a mold according to specifications.

Dimensions of the ball hitch may be made with various shank lengths and diameters, ball diameters and weight capacities to meet the selected towing specifications. Weight capacities on the ball hitch are not limited to, but may range between 3,500 pounds (lbs.) to 38,000 lbs.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

We claim:

1. A ball hitch comprising:
a. a base flange;
b. a coupler ball;
c. a stem portion connected between the coupler ball and the base flange;
d. a lubricant inlet disposed in the base flange;
e. a lubricant outlet disposed in the coupler ball at a lateral side opposite the lubricant inlet; and
f. a lubricant channel extending between the lubricant inlet and the lubricant outlet.

2. The ball hitch of claim 1, wherein the lubricant channel is canted at an angle of between 15 to 30 degrees to the central vertical axis of the coupler ball.

3. The ball hitch of claim 1, wherein the lubricant channel extends horizontally through the base flange from the lubricant inlet towards the central vertical axis of the coupler ball.

4. The ball hitch of claim 3, wherein the lubricant channel extends vertically in the central vertical axis through the coupler ball.

5. The ball hitch of claim 1, further comprising:
a. a lubricant fitting disposed at the lubricant inlet within a recessed indentation inside the base flange.

6. The ball hitch of claim 5, wherein the lubricant fitting is a zerk that is countersunk and does not protrude from the base flange.

7. The ball hitch of claim 1, wherein the diameter of the lubricant channel is from a sixteenth of an inch to a quarter of an inch.

8. The ball hitch of claim 7, wherein the diameter of the lubricant channel is eighth of an inch.

9. The ball hitch of claim 1, wherein the diameter of the lubricant channel decreases from a quarter of an inch at the lubricant inlet down to less than or equal to a sixteenth of an inch at the lubricant outlet.
